(19) United States
(12) Patent Application Publication
(10) Pub. No.: US 2025/0184683 A1
(43) Pub. Date: Jun. 5, 2025

(54) METHOD AND DEVICE FOR CONFIGURING AN AUDIO SYSTEM

(71) Applicant: SAGEMCOM BROADBAND SAS, BOIS-COLOMBES (FR)

(72) Inventors: Piero INDIVERI, BOIS-COLOMBES (FR); Stéphane DELPLACE, BOIS-COLOMBES (FR)

(21) Appl. No.: 18/967,597

(22) Filed: Dec. 3, 2024

(30) Foreign Application Priority Data
Dec. 4, 2023 (FR) 2313491

(51) Int. Cl. H04S 7/00

(52) U.S. Cl. CPC H04S 7/303; H04S 7/40; H04S 2400/11

(57) ABSTRACT

A method of configuring an audio system includes configuring an audio processing processor to generate one or more audio signals feeding one or more respective audio sources based on one or more geometric parameters defining a listening area selected by a user, obtaining, from a camera, a video of a place where sound is distributed by the audio source(s), generating a signal representing a video to be displayed on a display device comprising all or part of the video obtained by the camera, the superimposition, in the video to be displayed, of at least one graphical representation of a listening area among several listening areas that constitutes a real-time visual feedback adapted to help the user to configure the place in which the listening area is located, and obtaining data representing a user's choice of a displayed listening zone, for configuring the audio processing processor.

### CROSS-REFERENCE TO RELATED APPLICATIONS

The present application claims priority to French Application No. 2313491 filed with the Intellectual Property Office of France on Dec. 4, 2023, which is incorporated herein by reference in its entirety for all purposes.

### TECHNICAL FIELD

A method and a device for configuring an audio system using a camera to select a listening area are described. The method and the device may notably be used to configure a home audio system.

### TECHNICAL BACKGROUND

An audio system, for example a home audio system, can be associated with a listening area, which represents a sound distribution space wherein a listener enjoys sound that meets desired criteria. Determining such an area may require the use of various additional equipment. For example, it may be necessary to use a microphone in order to pick up sound in the room wherein the audio system is installed, or else to use a cell phone. The recorded sound must then be processed by dedicated software to identify the listening area. Other solutions may require advanced knowledge of acoustics and sound engineering. The problem is compounded if several listening areas are considered; these listening areas corresponding for example to different configurations for processing the sound by the audio system. To switch from one area to another, it is necessary to repeat the above operations.

An intuitive audio system configuration solution is proposed, allowing simple determination of the listening area(s).

### SUMMARY

1. One or more embodiments relate to a method of configuring an audio system implemented by a device comprising a processor, the method comprising
configuring an audio processing processor to generate one or more audio signals feeding one or more respective audio sources based on one or more geometric parameters defining a listening area selected by a user,
the method further comprising:
   obtaining, from a camera, a video of a place where sound is distributed by the audio source(s);
   generating a signal representing a video to be displayed on a display device, the video to be displayed comprising all or part of the video obtained by the camera; the superimposition, in the video to be displayed, of at least one graphical representation of a listening area among several listening areas, the video with superimposition displayed on the screen constituting real-time visual feedback adapted to help the user to configure the place in which the listening area is located;
obtaining data representing a user's choice of a displayed listening area, for configuring the audio processing processor.

Real-time visual feedback using the camera helps the user to configure the places and/or choose a listening area and the geometric parameters thereof. The video to be displayed may comprise only part of the video obtained by the camera, in the sense that only part of the field of view of the camera is reproduced in the video to be displayed.

According to one or more embodiments, the geometrical parameter(s) comprise(s) at least one of:
a distance between the listening area and the audio source(s);
a width of the listening area.

According to one or more example embodiments, a listening area is an area wherein the sound produced by the audio source(s) meets one or more quality criteria.

According to one or more example embodiments, the method comprises superimposing, in the video to be displayed, a menu comprising several value choices for a parameter, highlighting a current parameter value choice, as well as graphically representing a listening area corresponding only to a current parameter value choice.

According to one or more example embodiments, the method comprises displaying an invitation to a user to move a piece of furniture in the place of distribution based on the graphical representation.

According to one or more example embodiments, the audio source(s) are orientable, the orientation of the audio source(s) comprising one of:
displaying a message inviting a user to orient one or more audio sources based on a selected listening area;
generating a signal for controlling an orientation motor of one or more audio sources based on a selected listening area.

According to one or more example embodiments, a geometric parameter is defined by a value, or a range of values, or an open range.

One or more example embodiments relate to a device comprising a camera, at least one audio source, a processor and a memory comprising software code; the processor, when executing the software code, causing the device to implement one of the described methods.

According to one or more embodiments, the at least one audio source can be oriented either manually, or by means of an actuator.

### BRIEF DESCRIPTION OF THE FIGURES

Further features and advantages will become apparent from the following detailed description, which may be understood with reference to the attached drawings in which:

FIG. 1 is a schematic diagram of an audio system according to one or more embodiments;

FIG. 2 is a schematic diagram of a top view of a room wherein the system shown in FIG. 1 is installed;

FIG. 3 is a flowchart of a configuration method according to one or more embodiments;

FIG. 4 is a schematic representation of a video image that can be displayed with a graphical representation of a listening area superimposed;

FIG. 5 is a first schematic representation of a video image showing the screen display at various stages;

FIG. 6 is a second schematic representation of a video image showing the screen display at various stages;

FIG. 7 is a third schematic representation of a video image showing the screen display at various stages;

FIG. 8 is a fourth schematic representation of a video image showing the screen display at various stages;

FIG. 9 is a fifth schematic representation of a video image showing the screen display at various stages;

FIG. 10 is a sixth schematic representation of a video image showing the screen display at various stages;

FIG. 11 is a schematic diagram of a part of the device according to one or more embodiments showing examples of possible orientations of an audio source;

FIG. 12 is a schematic representation of a video image showing the on-screen display of menu items having the orientations shown in FIG. 11, and the selection of a first orientation;

FIG. 13 is a schematic representation of a video image showing the on-screen display of menu items having the orientations shown in FIG. 11, and the selection of a second orientation;

FIG. 14 is a schematic diagram showing a method for determining the position of a point in the image based on a distance;

FIG. 15 is a schematic diagram showing the positioning of certain elements of FIG. 14 in the displayed video image.

### DETAILED DESCRIPTION

In the following description, identical, similar or analogous elements will be referred to by the same reference numbers. The block diagrams, flowcharts and message sequence diagrams in the figures shows the architecture, functionalities and operation of systems, apparatuses, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or apparatus to implement all or part of the functionalities of the blocks and/or steps of the processes or methods according to the exemplary embodiments. The software code can be stored in non-volatile memory or a non-volatile storage medium (USB key, memory card or other medium) that can be read directly or via a suitable interface by the processor or controller.

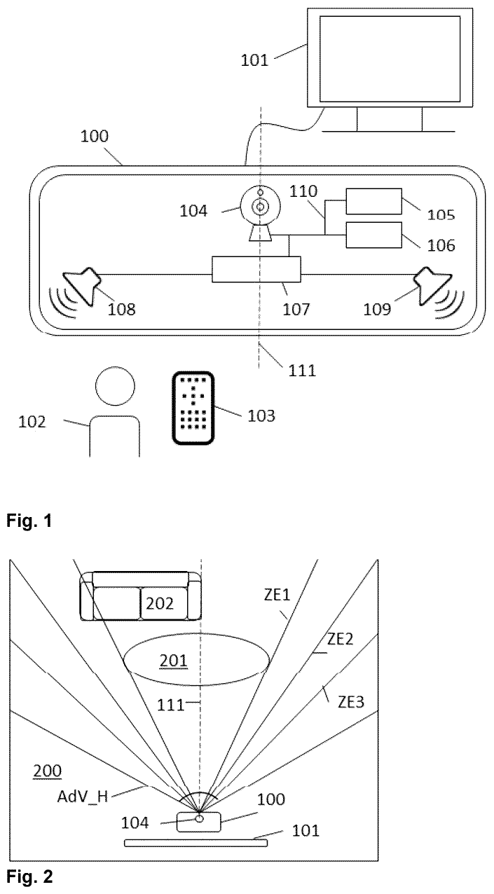

FIG. 1 is a schematic diagram of an audio system showing one or more non-limiting embodiments. The system shown in FIG. 1 comprises a configuration device 100 and a screen 101. The device 100 can be controlled by a user 102 using a remote control 103. The device 100 comprises a camera 104, a processor 105, a non-volatile memory 106 comprising software code, and an audio processing processor 107. The various components of the device 100 are connected by an internal bus 110. The audio processor 107 receives audio data as input and generates audio signals intended to be reproduced by one or more audio sources, represented herein by two loudspeakers 108 and 109. The device 100 further comprises an interface (not shown) through which it is connected to the screen 101. This interface is, for example, an HDMI interface. The device 100 is adapted to generate a video signal for display on the screen 101. The video signal is generated, for example, by the processor 104. The system shown in FIG. 1 is given for illustrative purposes to clearly present the example embodiments and an actual implementation may of course differ. In addition, the device 100 may comprise only one or more than two loudspeakers. Depending on the implementations, the loudspeakers 108 and 109 are fixed or orientable. In the case of orientable loudspeakers, the orientation can be adjusted manually or via actuators such as electric motors. According to some implementations, position sensors are associated with the manually orientable loudspeakers to allow the device 100 to determine the orientation.

For example, the device 100 integrates a video receiver and decoder functionality in addition to the audio and camera functionalities (a product known as a‘video sound box’). It should also be noted that both the functionality of the processor 105 and that of the processor 107 can be implemented with more than one component, or else be jointly implemented by one or more components. For example, a single processor can be used to implement both functionalities. In the example shown in FIG. 1, the device 100 comprises two audio sources and the camera is positioned on an axis of symmetry 111 of these audio sources. However, this is not mandatory.

FIG. 2 is a schematic diagram showing an example of how the system shown in FIG. 1 can be positioned in a room 200. The camera 104 of the device 100 has a horizontal viewing angle AdV_V. According to the example of FIG. 2, the room also comprises furniture such as a sofa 202. A listening area 201 is represented schematically by an ellipse, but the actual shape thereof depends on the implementation, the number of loudspeakers, etc. A listening area is a sound distribution area wherein a listener benefits from sound that meets desired criteria, for example quality criteria. Such a criterion is, for example, that the phase shift between the sounds produced by the different loudspeakers is below a certain threshold, so that stereophonic or spatial perception is of a desired quality level. The geometric parameters defining a listening area comprise, for example, the distance of a listening area from the audio sources, or else the width of the area. Audio processing receives at least these geometric parameters as input and generates corresponding audio signals.

According to one or more embodiments, a graphical representation of a listening area is displayed on the screen, superimposed on a video image obtained by the camera 104 in the room wherein the device 100 is located. This visual feedback helps the user in real time to configure the rooms and/or choose a listening area. This choice may for example comprise selecting a listening area from a list, selecting one or more parameters defining a listening area or any other action or series of actions resulting in the user determining a listening area. The configuration of the rooms comprises for example moving furniture so that a listener can easily position himself in the listening area. In the specific context of the example shown in FIG. 2, this can be achieved for example by placing the sofa 201 in the listening area. The choice of a listening area allows a new listening area to be obtained, for example one that is wider or narrower or more or less distant from the device 100. This choice of a new listening area is followed by a configuration of the audio processing carried out by the device 100 so that the characteristics of the sound produced correspond to the new listening area. The display is updated on the fly based on the user's choice.

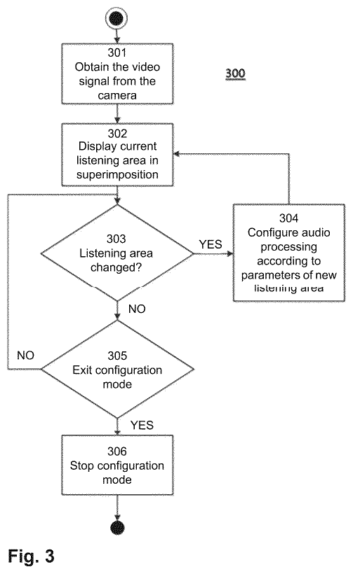

FIG. 3 is a flowchart of a calibration method 300 according to one or more example embodiments. In a first step (301), a signal representing the video of the room wherein the audio system is distributed is obtained from the camera. In a second step (302), a graphical representation of the currently configured listening area is superimposed on this video. A corresponding video signal is generated for display on the screen 101.

The user 102 may then decide to change the listening area. Various ways of making this choice can then be envisaged, some of which are shown in FIGS. 5 to 10 described below.

The audio processing is adapted to the new listening area and the new listening area is superimposed in 302, allowing the user both to appreciate the new sound processing and to visualize the new listening area.

According to one alternative, the user is offered the option of selecting a listening area for superimposed display, but not actually configuring audio processing until further validation of a selected listening area. This variant allows the user to view a listening area (or several listening areas consecutively) without modifying the audio processing configuration parameters.

If the user decides not to change—or no longer to change—the current listening area in 303, he is prompted to exit the configuration mode in 305. If this is the case, the configuration mode is stopped in 306. If not, the process loops back to 303.

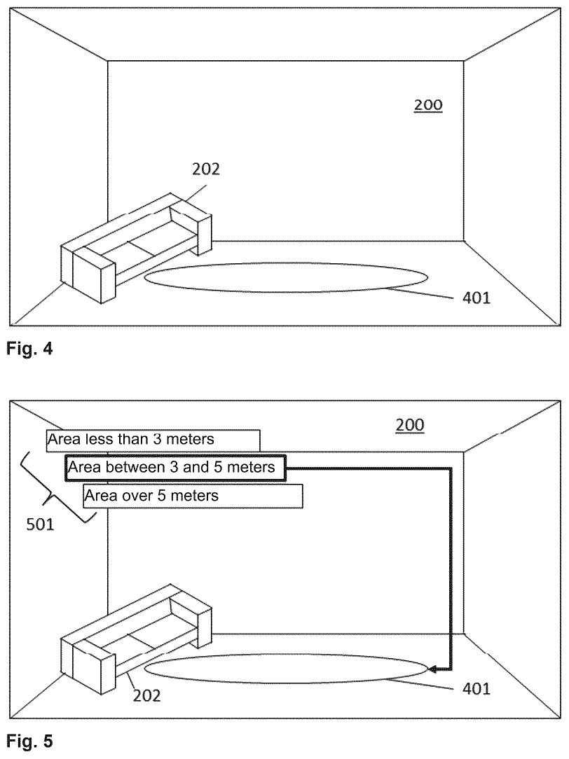

FIG. 4 is a schematic representation of a video image that can be displayed with a graphical representation of a listening area 401 superimposed.

FIGS. 5 to 10 are schematic representations of video images showing the on-screen display at various stages of the process. Some of these figures notably show particular implementations for configuring or selecting a listening area. Some implementations use menus, although it should be noted that these implementations are only give as examples and that other ways of configuring a listening area can be implemented, notably by explicitly entering parameter values for a desired listening area.

FIG. 5 shows an initial positioning of the listening area visually delimited by the graphical representation 401, with a sofa 202 positioned to the left of the room, outside the current listening area. The user can then either choose another listening area and/or move the sofa. The superimposed video displayed on the screen provides immediate visual feedback in real time, helping the user to correctly move his furniture to a location in the room within the current listening area.

According to one or more embodiments, the user can select a listening area by configuring a distance between the device 100 and the listening area. FIG. 5 shows a possible example of choices proposed in 501, with a limited number of predefined choices presented on screen as individually selectable menu items. In FIG. 5, three choices are displayed, namely a distance of less than three meters, a distance of between 3 and 5 meters and a distance of more than 5 meters. Note that the distance is herein defined by a range, but it is perfectly possible to define a distance by a single value. The distance range indicates for example the distance limit for which the audio processing input parameters will not be modified as long as the user's distance remains within the limit. In the example shown in FIG. 5, the intermediate distance is selected, the corresponding element is visually highlighted, and the corresponding graphical representation of the listening area is superimposed on the video image.

Users can either change the location of their furniture, or vary the listening area.

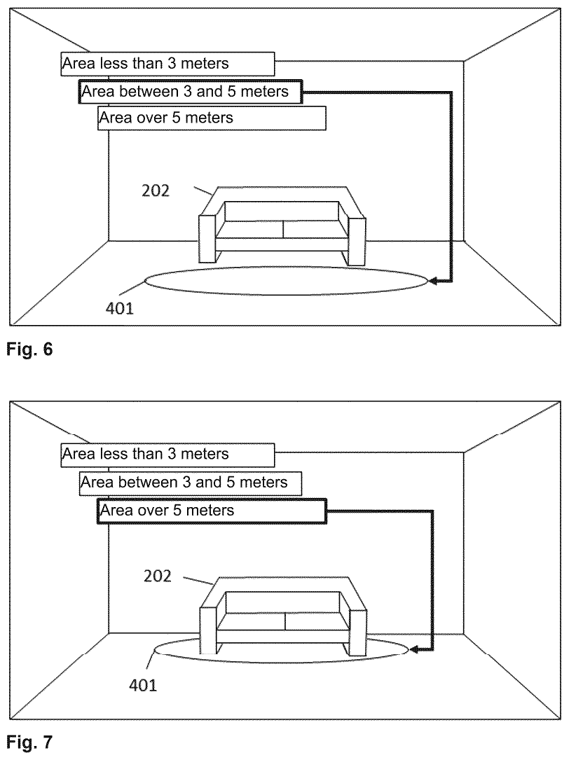

The user can, for example, align his sofa with the displayed listening area and/or indicate how far away from the device he wishes to place the listening area. In this context, FIG. 6 shows the alignment. Then the user selects the distance corresponding to the location (the furthest distance in the example). This latter case is shown in FIG. 7.

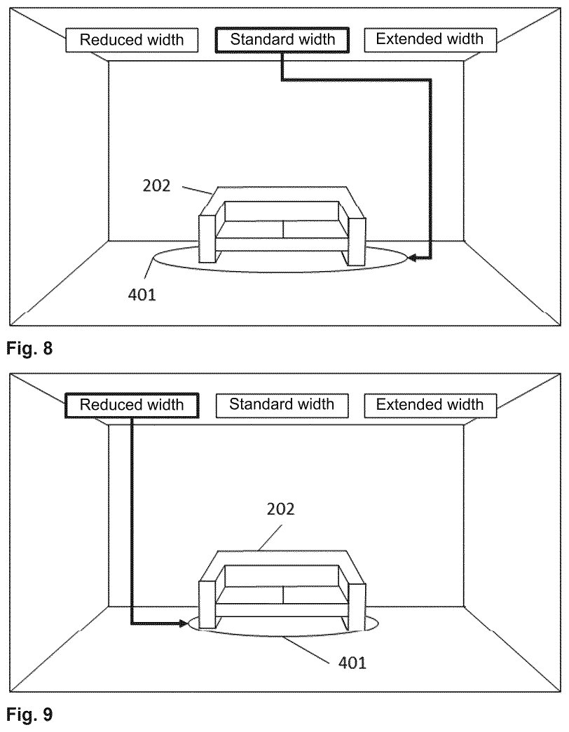

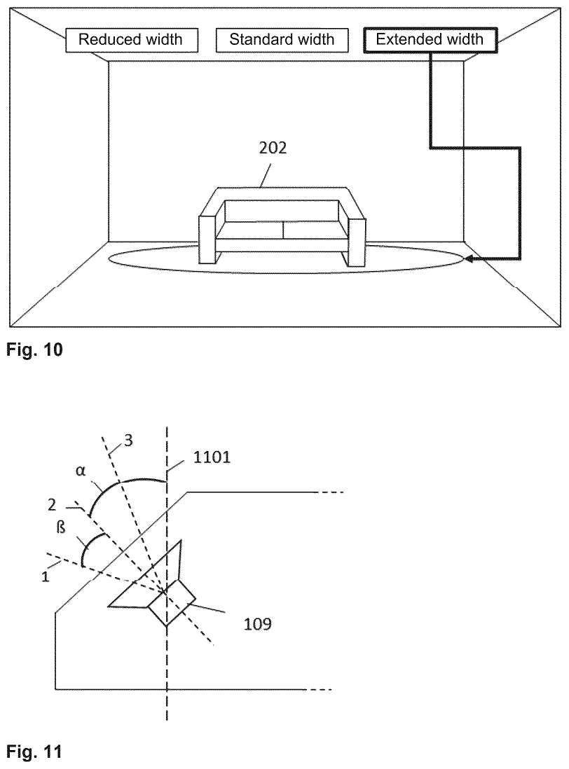

According to one or more embodiments, the user can also configure the width of the listening area. FIG. 8 shows an example of width selection, with a limited number of predefined choices presented on screen as individually selectable menu items. In FIG. 8, three choices are displayed: namely, reduced width, standard width and extended width. In the example shown in FIG. 8, the standard width has been selected and the corresponding item is visually highlighted. FIGS. 9 and 10 respectively show the video image with graphical representations of reduced-width and extended-width areas.

According to one or more embodiments, the orientation of the sound source(s) can be modified. A listening area is associated with each orientation of the sound source(s), along with a corresponding graphical representation.

According to a particular embodiment, the device 100 then allows the user to preview the graphical representation of a listening area for a particular orientation.

According to another particular embodiment, a user first changes the orientation of the sound sources, and the device 100 then generates a display of a graphical representation of the listening area corresponding to this orientation. The device determines the orientation of the sources either automatically using suitable sensors, or on the basis of information supplied by the user. The use of sensors also makes it possible to check that the orientations of several audio sources correspond to an authorized configuration and thus warn the user accordingly. For example, the user may have oriented two symmetrical sources with non-symmetrical orientations.

In another particular embodiment, which can be combined with either of the above embodiments, the orientation of the audio source(s) can be adjusted by one or more actuators. An actuator can be controlled by the processor 105 based on a command entered by the user. This command is for example a choice of a particular orientation. The orientation can be adjusted as required once the user is satisfied with a previewed listening area, or else immediately based on a viewed listening area.

According to one or more embodiments, the orientation of the audio sources is a configuration parameter for processing audio data by the audio processor 107.

FIG. 11 is a schematic diagram of part of the device 100 in the case where this device comprises two audio sources which, combined, generate stereo sound. FIG. 11 shows the left-hand part of the device, the audio source being able to assume three predefined orientations. The default orientation is, for example, an angle α of 45° relative to an axis parallel to the axis of symmetry of the device, with the other two positions varying by, for example, ±β° from the default position. Of course, other positions can also be selected.

In the example shown in FIG. 11, the three possible orientations can be arbitrarily labeled, for example from 1 to 3, with orientation 2 being the default orientation. This numbering can optionally be transferred to the housing of the device 100 for easy identification of a current orientation of the audio source(s).

In other embodiments, the orientation can take on more or less distinct values. In yet other embodiments, the orientation of an audio source is continuously adjustable.

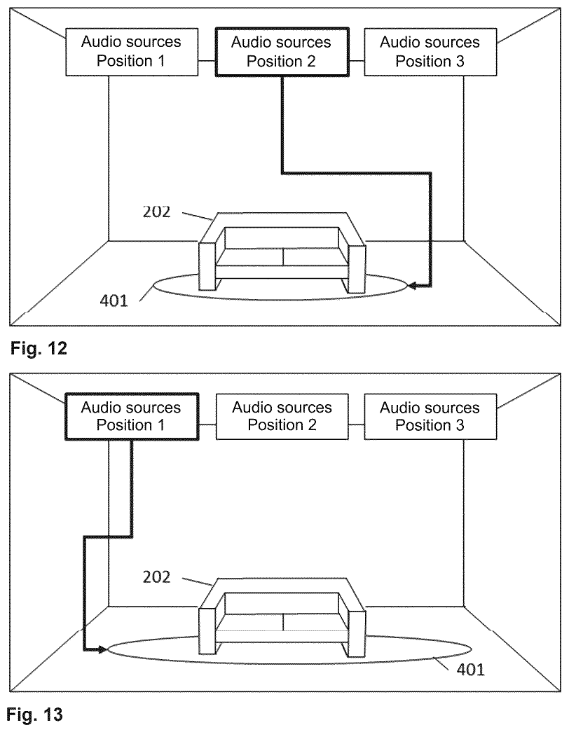

FIG. 12 is a schematic representation of a video image showing the on-screen display of three menu items having the orientations shown in FIG. 11. A graphical representation of the listening area corresponding to the current orientation is superimposed. The corresponding item is visually highlighted.

Similarly, FIG. 13 shows the case where the first orientation is selected, giving a wider listening area.

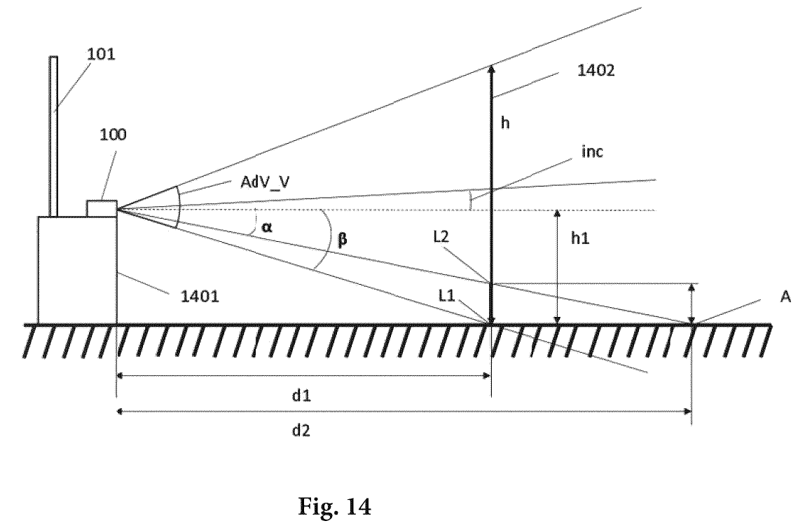

FIG. 14 is a schematic diagram showing a method for determining the position of a point in the image based on a distance. This method can be used to place a graphical representation at a given distance from the device 100.

The diagram in FIG. 14 shows a side view of the device 100 placed on a piece of furniture 1401 just in front of the screen 101. The camera of the device 100 has a vertical viewing angle AdV_V, in degrees. It is positioned at a height h1 from the ground. The video feedback plane 1402 of the camera has a height h in number of pixels. The ground represented by the bottom L1 of this plane is at a distance d1 from the camera. The camera can be tilted at an ‘inc’ angle relative to the horizontal.

Consider resV, the vertical resolution of the camera sensor in number of pixels, and p, the angle corresponding to a pixel, in degrees, and nbpx, the number of pixels between the bottom of the video feedback plane of the camera, that is, line L1, and a line L2 of this plane, line L2 corresponding in plane 1402 to a line A in the room and whose distance d2 from the camera is to be determined. nbpx therefore represents a number of pixels on a vertical line in the image, between the two lines L1 and L2. α and β represent respectively the angle between the horizontal and the straight line passing through the camera and line L2, and the angle between the horizontal and the straight line passing through the camera and L1. Line L2 is the projection of line A onto plane 1402 along the straight line passing through the camera and line A.

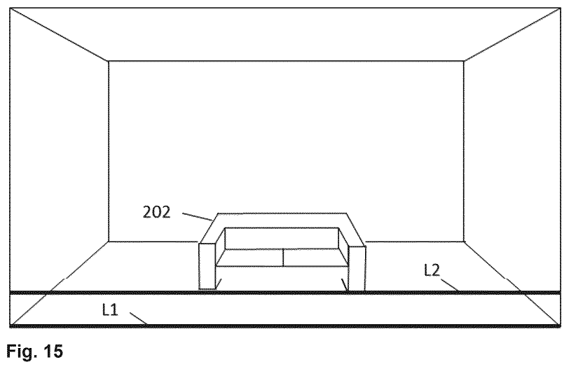

FIG. 15 is a schematic diagram showing the placement of lines L1 and L2 in the displayed image. Lines L2 and A overlap in this image.

It is possible to assume:

$$d 1 = \frac{h 1}{tan β} et d 2 = \frac{h 1}{tan α} \qquad [ Equation 1 ]$$

$$β = \frac{AdV\_V}{2} - inc \qquad [ Equation 2 ]$$

$$ρ = \frac{AdV\_V}{resV} \qquad [ Equation 3 ]$$

$$β - α = n b p x \times ρ \qquad [ Equation 4 ]$$

$$α = \frac{AdV\_V}{2} - i n c - n b p x \times \frac{AdV\_V}{r e s V} \qquad [ Equation 5 ]$$

$$d 1 = \frac{h 1}{tan ( \frac{AdV\_V}{2} - i n c )} \qquad [ Equation 6 ]$$

$$d 2 = \frac{h 1}{tan ( \frac{AdV\_V}{2} - i n c - n b p x \times \frac{AdV\_V}{r e s V} )} \qquad [ Equation 7 ]$$

It is thus possible to obtain d2 for a given value of nbpx, and conversely, nbpx can be obtained for a given value of d2. In this way, it is possible to place a graphical representation of a listening area in the image based on the desired distance, and in particular between two values of distance d2. For example, if we consider AdV_V=46°, inc=6°, resV=1080px, h1=0.8 m and nbpx chosen at 270 pixels, then d1=2.6 m and d2=8.3 m.

With regard to the different widths of listening areas, it is possible to simply define the width of a listening area as a fraction of the viewing angle of the camera. Returning to FIG. 2 for example, an extended width ZE3 corresponds to ¾ of the viewing angle AdV_H of the camera, a standard width ZE2 corresponds to ½ of this viewing angle, while a reduced width ZE1 corresponds to ¼ of this viewing angle. If the horizontal resolution of the camera sensor is resH, then it is sufficient to apply a coefficient of ¾, ½, or ¼ to obtain the pixel width of the listening area.

1. A method of configuring an audio system implemented by a device comprising a processor, the method comprising
configuring an audio processing processor to generate one or more audio signals feeding one or more respective audio sources based on one or more geometric parameters defining a listening area selected by a user,
the method further comprising:
obtaining, from a camera, a video of a place where sound is distributed by the audio source(s);
generating a signal representing a video to be displayed on a display device, the video to be displayed comprising all or part of the video obtained by the camera;
the superimposition, in the video to be displayed, of at least one graphical representation of a listening area among several listening areas, the video with superimposition displayed on the screen constituting a real-time visual feedback adapted to help the user to configure the place in which the listening area is located;
obtaining data representing a user's choice of a displayed listening area, for configuring the audio processing processor.

2. The method according to claim 1, the geometric parameter(s) comprising at least one of:
a distance between the listening area and the audio source(s);
a width of the listening area.

3. The method according to claim 1, wherein a listening area is an area wherein the sound produced by the audio source(s) meets one or more quality criteria.

4. The method according to claim 1, comprising the superimposition, in the video to be displayed, of a menu comprising several choices of value for a parameter, highlighting a current parameter value choice, as well as graphically representing a listening area corresponding only to a current parameter value choice.

5. The method according to claim 1, comprising displaying an invitation to a user to move a piece of furniture in the place of distribution based on the graphical representation.

6. The method according to claim 1, wherein the audio source(s) are orientable, the orientation of the audio source(s) comprising one of:
displaying a message inviting a user to orient one or more audio sources based on a selected listening area;
generating a signal for controlling an orientation motor of one or more audio sources based on a selected listening area.

7. The method according to claim 1, a geometric parameter being defined by a value, or a range of values, or an open range.

8. A device comprising a camera, at least one audio source, a processor and a memory comprising the software code; the processor, when executing the software code, causing the device to implement a method according to claim 1.

9. The device according to claim 8, the at least one audio source being orientable either manually, or by means of an actuator.
